(19) United States
(12) Patent Application Publication
(10) Pub. No.: US 2008/0030562 A1
(43) Pub. Date: Feb. 7, 2008

(54) METHODS AND APPARATUS FOR IMPROVED INK FOR INKJET PRINTING

(75) Inventor: Lizhong Sun, San Jose, CA (US)

Correspondence Address: DUGAN & DUGAN, PC, 245 Saw Mill River Road, Suite 309, Hawthorne, NY, 10532, US

(73) Assignee: APPLIED MATERIALS, INC.

(21) Appl. No.: 11/831,676

(22) Filed: Jul. 31, 2007

Related U.S. Application Data
(60) Provisional application No. 60/821,212, filed on Aug. 2, 2006.

(51) Int. Cl. B41J 2/01; C09D 11/02

(52) U.S. Cl. 347/102; 106/31.6

(57) ABSTRACT

Methods and apparatus are provided for an improved ink composition for inkjet printing of color filters for flat panel displays. The ink composition includes an ink including at least one pigment and having a surface tension, and an additive adapted to disperse the pigment in the ink and to reduce the surface tension of the ink so that when the ink composition is deposited in a pixel well, a fill profile of the ink composition in the pixel well is flattened or otherwise improved. Numerous other aspects are provided.

The present application claims priority to commonly-assigned, co-pending U.S. Provisional Patent Application Ser. No. 60/821,212 filed Aug. 2, 2006 and entitled “METHODS AND APPARATUS FOR IMPROVED INK FOR INKJET PRINTING” (Attorney Docket No. 11336/L) which is hereby incorporated herein by reference in its entirety for all purposes.

### RELATED APPLICATIONS

The present application is related to the following commonly-assigned, co-pending U.S. patent applications, each of which is hereby incorporated herein by reference in its entirety for all purposes:

U.S. patent application Ser. No. 11/182,501, filed Jul. 15, 2005 and entitled “A RED PRINTING INK FOR COLOR FILTER APPLICATIONS” (Attorney Docket No. 10140);

U.S. patent application Ser. No. 11/183,188, filed Jul. 15, 2005 and entitled “A GREEN PRINTING INK FOR COLOR FILTER APPLICATIONS” (Attorney Docket No. 10141);

U.S. patent application Ser. No. 11/182,491, filed Jul. 15, 2005 and entitled “A BLUE PRINTING INK FOR COLOR FILTER APPLICATIONS” (Attorney Docket No. 10142);

U.S. patent application Ser. No. 11/494,286, filed Jul. 27, 2006 and entitled “INKS FOR DISPLAY DEVICE MANUFACTURING AND METHODS OF MANUFACTURING AND USING THE SAME” (Attorney Docket No. 11335); and

U.S. Provisional Patent Application Ser. No. 60/625,550, filed Nov. 4, 2004 and entitled “APPARATUS AND METHODS FOR FORMING COLOR FILTERS IN A FLAT PANEL DISPLAY BY USING INKJETTING” (Attorney Docket No. 9521/L).

### FIELD OF THE INVENTION

The present invention relates generally to inkjet printing used in electronic display manufacturing, and is more particularly concerned with apparatus and methods for forming a color filter for use in a flat panel display.

### BACKGROUND OF THE INVENTION

Flat panel displays (FPDs) have become the favored display technology for computers, televisions, and personal electronic devices such as cell phones, personal digital assistants, etc. Liquid crystal displays (LCDs) are a preferred type of commercially available FPDs. Different colors are obtained in liquid crystal displays by transmitting light through a color filter located on a substrate of an LCD. The color filter includes pixels, wherein each pixel may include three or more colors, typically red, green, and blue. Each color of a pixel may be considered a sub-pixel. Typically, each sub-pixel is surrounded by a black matrix material that provides an opaque area between sub-pixels and therefore prevents light leakage in the thin film transistors of the LCD. FIG. 1 is a top view of two adjacent pixels 1 and 2 of a color filter 10. Pixel 1 includes three sub-pixels 3, 4, and 5, and pixel 2 includes three sub-pixels 6, 7, and 8. Black matrix material 9 surrounds and separates each of the sub-pixels 3, 4, 5, 6, 7, and 8. FIG. 2 is a side, cross-sectional view of color filter 10 showing substrate 12 upon which the black matrix material 9 and the pixels 1 and 2 (shown in FIG. 1) are formed. The sub-pixels 3, 4, and 5 are filled with three different colors of ink, 14, 16, and 18, respectively.

Traditional methods of producing color filters, such as dyeing, lithography, and electrodeposition, require the sequential introduction of the three colors. That is, a first set of pixels having one color is produced by a series of steps, whereupon the process must be repeated twice more to apply all three colors. The series of steps involved in this process includes at least one curing phase in which the deposited liquid color agent must be transformed into a solid, permanent form.

Thus, such traditional methods of producing color filters can be very time consuming. Traditional color filter production methods also require expensive materials and typically have a low yield, which further increases the cost of producing color filters. Also, as each color agent is processed by a separate line of equipment, equipment costs for such traditional methods are high. In fact, the cost of manufacturing the color filter of a LCD may be as much as 20% of the total cost of manufacturing the LCD.

Methods of using inkjet systems that allow the deposition of all three colors simultaneously and that reduce the cost of manufacturing color filters have been developed. An inkjet system may be used to deposit different colors through different nozzles into sub-pixels created by a patterned black matrix on a substrate. However, due in part to the small size of the pixel wells, the level of precision required is significant. Further, to manufacture color filters cost effectively, the ink must be deposited accurately and reliably. Thus, what is needed are systems, methods, and compositions for depositing ink into color filter pixel wells accurately and reliably.

Further, the development of inkjet systems for manufacturing color filters of LCDs has created a need for inks that can be dispensed by an inkjet without clogging the inkjet, i.e., have good jettability, and that do not degrade during inkjetting. In particular, there is a need for inks that are physically and chemically stable before, during, and after inkjetting and that have a color chromaticity that meets color filter specifications for both computer and television monitors, as well as for other devices containing displays.

### SUMMARY OF THE INVENTION

In some aspects of the present invention, an ink composition for inkjet printing of color filters for flat panel displays is provided that includes an ink including at least one pigment and having a surface tension; and an additive adapted to disperse the pigment in the ink and to reduce the surface tension of the ink so that when the ink composition is deposited in a pixel well, a fill profile of the ink composition in the pixel well is affected.

In other aspects of the present invention, an ink for inkjet printing of color filters for flat panel displays is provided that includes one or more organic pigments; one or more monomers; one or more polymeric dispersants; one or more wetting agents; and one or more organic solvents. The polymeric dispersants and/or wetting agents may include an additive selected from the group consisting of cross-linkable silicone acrylate and radically cross-linkable silicone polyether acrylate in a concentration of approximately 0.1% to 0.5% by weight.

In yet another aspect of the present invention, a method of forming a display is provided that includes dispensing an ink composition into pixel wells on a substrate with an inkjet printing apparatus and curing the ink composition deposited on the substrate. The ink composition includes an ink including at least one pigment and having a surface tension, and an additive adapted to disperse the pigment in the ink and to reduce the surface tension of the ink so that when the ink composition is deposited in the pixel wells, a fill profile of the ink composition in the pixel wells is affected.

In still other aspects of the present invention, a display is provided that is produced by a process that includes dispensing an ink composition onto a substrate with an inkjet printing apparatus, wherein the ink composition includes an ink including at least one pigment and having a surface tension, and an additive adapted to disperse the pigment in the ink and to reduce the surface tension of the ink so that when the ink composition is deposited in a pixel well, a fill profile of the ink composition in the pixel well is affected; and curing the ink composition deposited on the substrate.

Other features and aspects of the present invention will become more fully apparent from the following detailed description, the appended claims and the accompanying drawings.

### BRIEF DESCRIPTION OF THE DRAWINGS

FIG. 1 is a top view of two pixels each containing three sub-pixels according to the prior art.

FIG. 2 is a side, cross-sectional view of the pixels of FIG. 1 according to the prior art.

FIG. 3 is a perspective view of an exemplary inkjet printing apparatus that may be used according to embodiments of the present invention.

FIGS. 4A to 4C are side, cross-sectional views of pixels formed according to embodiments of the present invention.

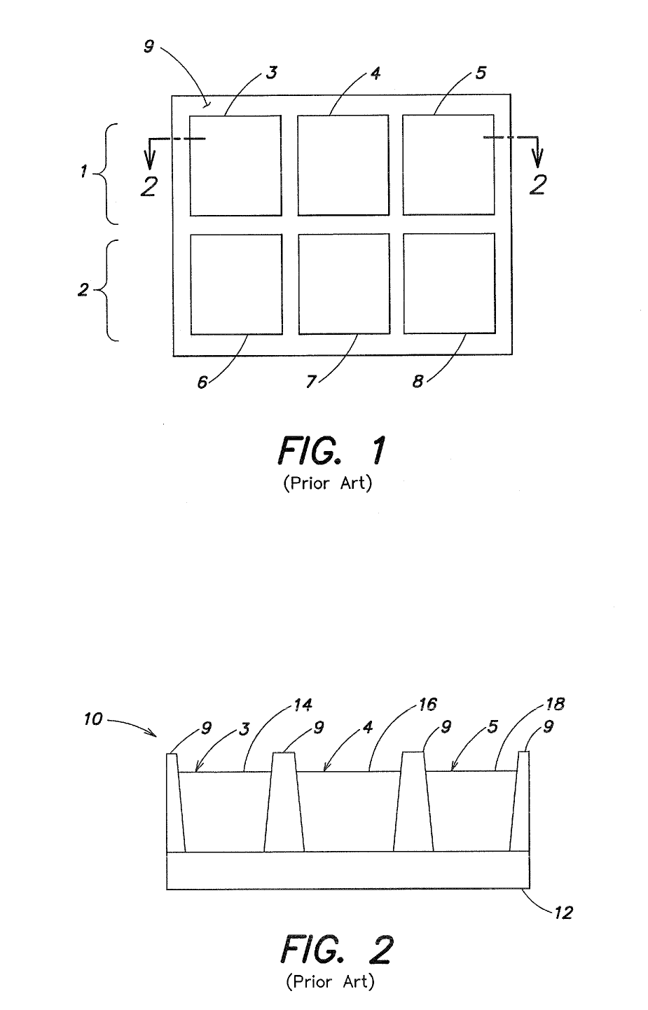

### DETAILED DESCRIPTION

The inventors of the present invention have determined that conventional inks that are commercially available may have chemical properties that interfere with reliably jetting the ink into pixel wells. Inkjet printing for flat panel display manufacturing uses ink that has physical properties such as a pigment dispersion characteristic and an amount of surface tension. The surface tension of the ink may, along with a wettability of the ink on the particular surface (e.g., the substrate and/or the black matrix material), affect the distribution of ink within a pixel well upon being deposited therein. Such properties of the ink may affect the characteristics (e.g., display brightness, reliability, etc.) of the pixel matrix. In accordance with the present invention, an additive to an ink improves (e.g., makes more uniform) the dispersion of pigments in the ink so that when the ink is deposited in a pixel well, the color of the pixel is more homogenous and consistent. In other words, by improving the dispersion of pigments in the ink, use of the additive may improve the quality of the pixel. For example, the color of each pixel filled with ink that includes the additive may be more uniform across the width and length of each of the pixels.

In some embodiments of the invention, the additive may be used to adjust that surface tension of the ink. By adjusting the surface tension, the ink additive may be used to both allow the formation of rounder, more consistently sized drops when the ink is jetted and to improve wetting of the surfaces of the color filter upon being deposited into the pixel wells of the color filter. For example, it may be desired to have a uniform cross-sectional ink profile that has a flat top surface that is flush with the top surface of the black matrix. By controlling the surface tension of the ink with the additive, an inkjet printer can more accurately deposit the correct quantity of ink and the wettability of the ink may allow the ink to fill the pixel wells with a cross-sectional profile closer to the desired flat profile.

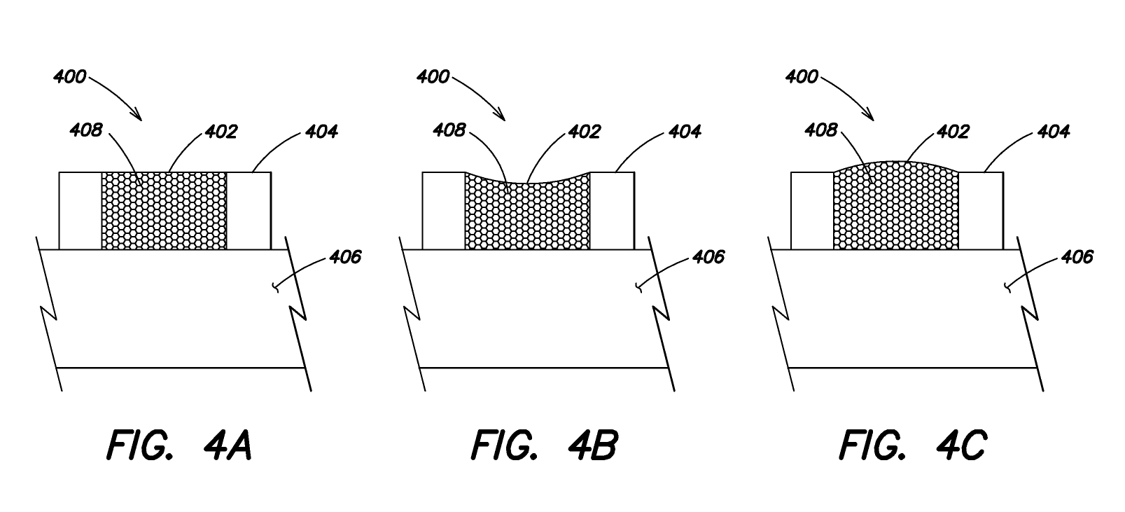

The ink additive may include a polymeric dispersant and/or a wetting agent such as cross-linkable silicone acrylate and/or radically cross-linkable silicone polyether acrylate. Commercially available examples of such acrylates are TEGO® RAD 2100 and TEGO® RAD 2250 manufactured by Degussa AG of Düsseldorf, Germany. Other similar products from other manufacturers are also available. A concentration range of the additive used in the ink of the present invention may be approximately 0.1% to 0.5% by weight. A preferred concentration range within the above range may be approximately 0.1% to 0.3% by weight. The ink additive is a surfactant and at the above concentrations also causes the surface tension of the ink to decrease by about 0.5 mN/meter at 20 degrees C., although larger or smaller decreases may occur. The surface tension of the ink changes based on the concentration of the additive. For example, as the concentration of the additive is increased, the surface tension of the ink may decrease. The preferred amount of surface tension for filling ink wells is from approximately 27 mN/meter to 30 mN/meters. Note that all surface tensions described herein are given at 20 degrees C. unless otherwise indicated. These and other features and embodiments of the invention are described below with reference to FIGS. 4A to 4C.

In some embodiments, the ink may be curable using an electron beam (“e-beam”) or other radiation curing systems. Thus the additive selected for use in the present invention may be compatible with/curable by use of e-beam application. In other embodiments, other curing methods such as ultraviolet light or heat application may be used.

In some embodiments, the substrate on which the ink is dispensed, e.g., the substrate for the color filter, may be any material having a high degree of optical transparency, such as glass. The substrate has a patterned black matrix material thereon. The black matrix material may be, for example, a black matrix resin or a chromium oxide-based black matrix material that includes a photoresist. Optionally, the substrate may be pre-treated, such as with a surface active compound prior to the deposition of the ink on the substrate to enhance the spread of the ink on the substrate and to enhance the formation of a desired surface profile of the ink on the substrate.

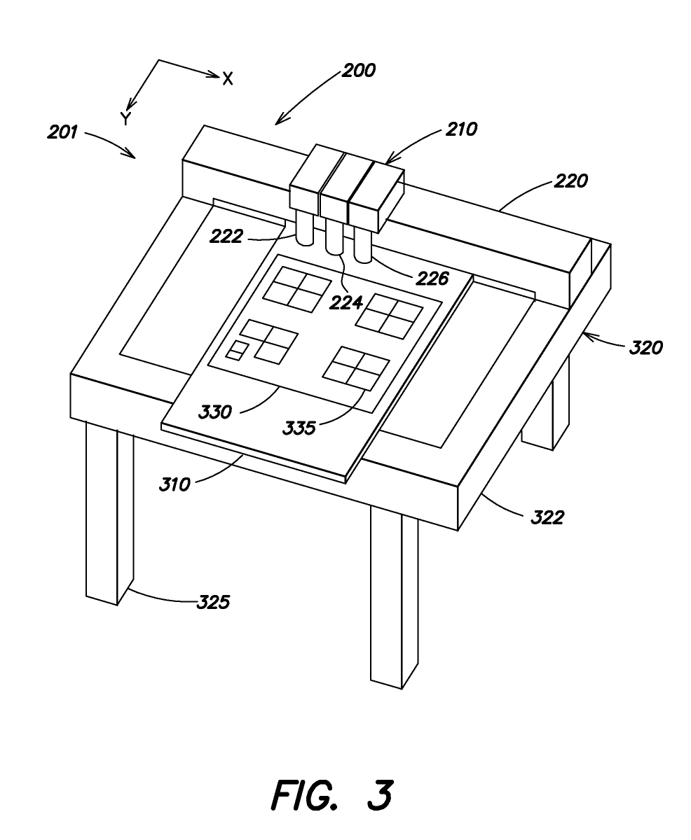

An example of an inkjet printing apparatus that may be used to deliver the inks provided according to embodiments of the invention is described below with respect to FIG. 3.

FIG. 3 is a perspective view of an exemplary embodiment of an inkjet printing apparatus 201 to form color filters in flat panel displays of the present invention. FIG. 3 illustrates components of a stage positioning system 320 which includes a stage 310. In the embodiment shown in FIG. 3, the stage 310 moves in the Y direction and the inkjet heads 222, 224, and 226 of an inkjet printing module 210 move in the X direction. In other embodiments, the stage 310 could move in both X and Y directions. A stage moving device (not shown) driven by one or more motors may be used to move the stage 310 in the Y-axis direction. In an exemplary embodiment, the substrate stage 310 can also be rotatable by using an appropriate stage rotating device (not shown). The stage 310 may also be rotated so as to rotate and/or orient the substrate 330 for aligning the substrate 330 and the display object(s) contained thereon with an inkjet printing module 210 of an inkjet printing system 200, both of which are described below.

The stage 310 may be of any appropriate or suitable size to support a substrate or substrates which are to be processed. In an exemplary embodiment, the apparatus 201 and its component parts can, for example, process substrates having dimensions of, for example, 5500 cm² and above. Other size substrates may also be processed. The apparatus 201 and its component parts can be designed and adapted to process substrates having any size.

The apparatus 201 also includes a stage positioning system 320 which supports the substrate stage 310 and which, in an exemplary embodiment, may include a top portion 322 and a plurality of legs 325. Each leg may be made from a heavy material (e.g., granite blocks) and may include an air cylinder or other cushioning mechanism (not shown) to isolate the stage 310 from vibrations (e.g., from the floor on which the apparatus 201 rests). The stage positioning system 320 may also include a controller (not shown) for controlling the operation of the stage moving device (not shown). The substrate 330 shown in FIG. 3 may include any number of display objects 335.

FIG. 3 also illustrates an inkjet printing module 210 of the inkjet printing system 200 and an inkjet printing module support 220 on which the inkjet printing module 210 is mounted. In an exemplary embodiment, the inkjet printing module 210 is moveable along the inkjet printing module support 220 by an inkjet positioning device (not shown). In the embodiment of FIG. 3, the inkjet printing module 210 includes three inkjet devices 222, 224 and 226. Other numbers of devices may be included. In an exemplary embodiment, each inkjet device 222, 224 and 226 may dispense a different color ink, for example red, green, blue, and optionally a clear or white ink, depending upon the color system being utilized. For example, a first inkjet device can dispense red ink, a second inkjet device can dispense green ink, and a third inkjet device can dispense blue ink. In another exemplary embodiment, any one or more of the inkjet devices can dispense the same color ink or a clear ink. Although described as being equipped with three inkjets devices, the inkjet printing module 210 and the apparatus 201 of the present invention can utilize any number of inkjet devices depending upon the application or use of the apparatus 201.

In some embodiments of the invention, each of the inkjet devices 222, 224 and 226 can be moved independently of each other while printing. This may be advantageous when printing more than one display object on a substrate. Each of the inkjet devices 222, 224 and 226 may include an inkjet head (not shown), an isolated head interface board (not shown), a height adjustment device (not shown), a head rotation actuator device (not shown), and an ink reservoir (not shown). For example, each of the inkjet heads may be rotated by a respective head rotation actuator device. In this manner, the pitch or saber angle at which an inkjet head is oriented relative to a print direction of a display object on a substrate may be changed depending upon a printing application. Each inkjet head may have numerous nozzles.

The inkjet printing apparatus described above with respect to FIG. 3 is one example of an inkjet printing apparatus that may be used with embodiments of the invention. Another example of an inkjet printing apparatus that may be used is described in previously incorporated, commonly assigned U.S. patent application Ser. No. 11/019,967 (Attorney Docket No. 9521), filed Dec. 22, 2004 and entitled “Apparatus and Methods for an Inkjet Head Support having an Inkjet Head Capable of Independent Lateral Movement.”

FIGS. 4A to 4C illustrate side views of a single exemplary pixel 400 which is a small portion of a color filter formed in accordance with methods of the present invention. The pixel 400 may include an ink deposit 402 in a pixel well 404 formed from, e.g., black matrix material. The ink deposit 402 may include a additive provided in accordance with the present invention. The pixel well 404 may be on the top surface of a substrate 406. As shown in FIG. 4A, pigments 408 may be dispersed throughout (e.g., evenly) the ink deposit 402.

The ink deposit 402 may also include the additive adapted to aid in the dispersion of the pigments 408. The pigments 408 may be any suitable pigment and/or particles. As indicated by the regular cross-hatching pattern in FIG. 4A, the pigments 408 are approximately uniformly dispersed. As indicated above, the additive may include, for example, cross-linkable silicone acrylate, radically cross-linkable silicone polyether acrylate, and/or another suitable compound and/mixture of compounds adapted to evenly disperse the pigments 408. The concentration of the additive to the other non-solvent components of the ink may be approximately 0.1% to 0.5%, although other concentrations may be employed. A preferred concentration range within the above range may be approximately 0.1% to 0.3% by weight. These values may be suitable for pigments such as, for example, Irgaphor Red BT-CF (PR 254, Fastogen Red ATY-TR (PR 177), Irgaphor Yellow 2R-CF (PY 139) and/or another practicable pigment.

A additive may also be a compound or combination of compounds adapted to control the surface tension of the ink deposit 402. By controlling the surface tension of the ink deposit 402, the additive may control both the roundness of jetted ink drops and the wetting of a surface of the ink well 404 by the ink deposit 402. Accordingly, controlling the surface tension of the ink deposit 402 affects the profile of the ink deposit 402 in terms of both quantity of ink and top surface shape. For example, by decreasing the surface tension of the ink deposit 402 the profile may be more concave as shown in FIG. 4B. Alternatively, increasing the surface tension of the ink deposit 402 may cause the profile to be more convex as shown in FIG. 4C.

As a result, by controlling the surface tension of the ink deposit 402, the profile of the ink deposit 402 may be controlled to achieve a desired profile. For example, the desired profile may be approximately flat as depicted in FIG. 4A. Accordingly, by adjusting (e.g., prior to filling the ink well 404 with the ink deposit 402) the amount and/or composition of the additive, the profile of the ink deposit 402 may be approximately flat.

As indicated above, the additive may include, for example, cross-linkable silicone acrylate, radically cross-linkable silicone polyether acrylate, and/or another suitable compound and/or mixture of compounds adapted to evenly disperse the pigments 108. The concentration of the additive to the other non-solvent components of the ink may be approximately 0.1% to 0.5% by weight, although other concentrations may be employed. A preferred concentration range within the above range may be approximately 0.1% to 0.3% by weight. These values may be suitable for pigments such as, for example, Irgaphor Red BT-CF (PR 254, Fastogen Red ATY-TR (PR 177), Irgaphor Yellow 2R-CF (PY 139) and/or another practicable pigment. The ink may include one or more organic pigments, one or more monomers, one or more polymeric dispersants, and one or more organic solvents. The ink may also include one or more oligomers. The one or more oligomers may be selected from the group consisting of aromatic monoacrylate oligomers, aliphatic diacrylate oligomers, aliphatic triacrylate oligomers, polyester acrylates, and combinations thereof. The ink may further include a wetting agent, an adhesion promoter, a defoamer, and/or an anti-skinning agent. The one or more organic pigments may be selected from the group consisting of PR 254 pigments, PR 177 pigments, and combinations thereof. The one or more monomers may be selected from the group consisting of diacrylate esters, acrylic esters, dipentaerythritol pentaacrylates and combinations thereof. The one or more polymeric dispersants may be selected from the group consisting of polymeric amides, polyesters, polyacrylic acid polymers, acrylic acid/maleic acid copolymers, silicone acrylate, silicone polyether acrylates, and combinations thereof. The one or more organic solvents may be selected from the group consisting of acetates, propionates, alcohols, and combinations thereof. The wetting agent may be selected from the group consisting of silicone polyether acrylates, polyamine amides, silicone acrylate, and polyesters. The adhesion promoter may be selected from the group consisting of trifunctional acrylate esters, trifunctional methacrylate esters, organic titanates, and zirconates. The defoamer may be a silicone defoamer. The anti-skinning agent may be selected from the group consisting of phenolic anti-oxidants, oximic anti-oxidants, anti-oxidants that are free of phenols and oximes, and combinations thereof.

The following non-limiting examples are provided to further illustrate the embodiments of the invention. However, the examples are not intended to be all inclusive and is not intended to limit the scope of the invention described herein.

### EXAMPLE 1

An ink for a color filter of a flat panel display was formed by mixing the following ingredients to form an ink having the following wt % of the ingredients: 4.0% SR238 (monomer), 2.5% SR9008 (adhesion promoter), 2.5% SR399LV (monomer), 0.25% TEGO® Rad 2100 (wetting agent), 0.50% BYK-088 (defoamer), 5.0% Ascinin® Anti Skin VP 0443 (anti-skinning agent), 10.1 wt % Irgaphor Red BT-CF (PR 254), 5.17 wt % Fastogen Red ATY-TR (PR 177), 6.05 wt % Irgaphor Yellow 2R-CF (PY 139), 29.3% n-amyl propionate (solvent), 6.84% MPA (solvent), 2.28% propyleneglycol diacetate (solvent), 21.3% EFKA® 7496 (35% active ingredient, polymeric dispersant), 0.93% Solsperse 22000 (polymeric dispersant), 3.25% CN2279 (oligomer). The ink was delivered to a substrate for a flat panel display using an inkjet printing apparatus. The ink was then cured by an electron beam curing system. The ink had a chromaticity as follows: x=0.6507, y=0.3299 and Y=18.907, as measured by a spectrophotomer]

### EXAMPLE 2

An ink for a color filter of a flat panel display was formed by mixing the following ingredients to form an ink having the following wt % of the ingredients: 4.0% SR238 (monomer), 2.5% SR9008 (adhesion promoter), 2.5% SR399LV (monomer), 0.25% TEGO® Rad 2250 (wetting agent), 0.50% BYK-088 (defoamer), 5.0% Ascinin® Anti Skin VP 0443 (anti-skinning agent), 10.1 wt % Irgaphor Red BT-CF (PR 254), 5.17 wt % Fastogen Red ATY-TR (PR 177), 6.05 wt % Irgaphor Yellow 2R-CF (PY 139), 29.3% n-amyl propionate (solvent), 6.84% MPA (solvent), 2.28% propyleneglycol diacetate (solvent), 21.3% EFKA® 7496 (35% active ingredient, polymeric dispersant), 0.93% Solsperse 22000 (polymeric dispersant), 3.25% CN2279 (oligomer). The ink was delivered to a substrate for a flat panel display using an inkjet printing apparatus. The red ink was then cured by an electron beam curing system. The ink had a chromaticity as follows: x=0.6507, y=0.3299 and Y=18.907, as measured by a spectrophotomer]

The foregoing description discloses only exemplary embodiments of the invention. Modifications of the above disclosed apparatus and method which fall within the scope of the invention will be readily apparent to those of ordinary skill in the art. For instance, an inkjet printing system employing sensors and/or cameras to detect whether pixels are being filled with a desired profile during printing may be used. Further, the present invention may also be applied to spacer formation, polarizer coating, and nanoparticle circuit forming.

Accordingly, while the present invention has been disclosed in connection with exemplary embodiments thereof, it should be understood that other embodiments may fall within the spirit and scope of the invention, as defined by the following claims.

What is claimed is:

1. An ink composition for inkjet printing of color filters for flat panel displays, comprising:
an ink including at least one pigment and having a surface tension; and
an additive adapted to disperse the pigment in the ink and to reduce the surface tension of the ink so that when the ink composition is deposited in a pixel well, a fill profile of the ink composition in the pixel well is affected.

2. The ink composition of claim 1 wherein the additive affects the fill profile by flattening the fill profile.

3. The ink composition of claim 1 wherein the additive is selected from the group consisting of:
cross-linkable silicone acrylate, and
radically cross-linkable silicone polyether acrylate; and
wherein the additive is added to the ink in a concentration of approximately 0.1% to 0.5% by weight.

4. The ink composition of claim 1, wherein the ink combined with the additive has a surface tension between about 22 mN/m and about 30 mN/m at 20° C.

5. An ink for inkjet printing of color filters for flat panel displays, comprising:
one or more organic pigments;
one or more monomers;
one or more polymeric dispersants; and
one or more organic solvents.

6. The ink of claim 5, wherein the ink has a surface tension between about 22 mN/m and about 30 mN/m at 20° C.

7. The ink of claim 5, further comprising one or more oligomers.

8. The ink of claim 5, further comprising one or more wetting agents, one or more adhesion promoters, one or more defoamers, and one or more anti-skinning agents.

9. The ink of claim 8, wherein the wetting agents include an additive selected from the group consisting of:
cross-linkable silicone acrylate, and
radically cross-linkable silicone polyether acrylate; and
wherein the additive is added to the ink in a concentration of approximately 0.1% to 0.5% by weight.

10. The ink of claim 5, wherein the polymeric dispersants include an additive selected from the group consisting of:
cross-linkable silicone acrylate, and
radically cross-linkable silicone polyether acrylate; and
wherein the additive is added to the ink in a concentration of approximately 0.1% to 0.5% by weight.

11. A method of forming a display, comprising:
dispensing an ink composition into pixel wells on a substrate with an inkjet printing apparatus, wherein the ink composition includes an ink including at least one pigment and having a surface tension, and an additive adapted to disperse the pigment in the ink and to reduce the surface tension of the ink so that when the ink composition is deposited in the pixel wells, a fill profile of the ink composition in the pixel wells is affected; and
curing the ink composition deposited on the substrate.

12. The method of claim 11 wherein the step of curing includes curing the ink composition using an electron beam.

13. The method of claim 11 wherein the additive affects the fill profile by flattening the fill profile.

14. The method of claim 11 wherein the additive is selected from the group consisting of:
cross-linkable silicone acrylate, and
radically cross-linkable silicone polyether acrylate; and
wherein the additive in the ink composition is present in a concentration of approximately 0.1% to 0.5% by weight.

15. The method of claim 11 wherein the ink composition has a surface tension between about 22 mN/m and about 30 mN/m at 20° C.

16. A display, produced by a process comprising:
dispensing an ink composition onto a substrate with an inkjet printing apparatus, wherein the ink composition includes an ink including at least one pigment and having a surface tension, and an additive adapted to disperse the pigment in the ink and to reduce the surface tension of the ink so that when the ink composition is deposited in a pixel well, a fill profile of the ink composition in the pixel well is affected; and
curing the ink composition deposited on the substrate.

17. The display of claim 16 wherein the step of curing, which is part of the process for producing the display, includes curing the ink composition using an electron beam.

18. The method of claim 16 wherein the additive affects the fill profile by flattening the fill profile.

19. The display of claim 16 wherein the additive is selected from the group consisting of:
cross-linkable silicone acrylate, and
radically cross-linkable silicone polyether acrylate; and
wherein the additive in the ink composition is present in a concentration of approximately 0.1% to 0.5% by weight.

20. The display of claim 16 wherein the ink composition has a surface tension between about 22 mN/m and about 30 mN/m at 20° C.
